(19) United States
(12) Patent Application Publication
(10) Pub. No.: US 2026/0035164 A1
(43) Pub. Date: Feb. 5, 2026

(54) BEVERAGE PODS WITH PRESSURE RELIEF VALVES

(71) Applicant: Nexe Innovations Inc., Surrey (CA)

(72) Inventor: Darren Joseph Footz, Surrey (CA)

(21) Appl. No.: 19/290,005

(22) Filed: Aug. 4, 2025

Related U.S. Application Data
(60) Provisional application No. 63/679,080, filed on Aug. 2, 2024.

(51) Int. Cl. B65D 85/804; B65D 51/16; F16K 15/14

(52) U.S. Cl. CPC B65D 85/8043; B65D 51/16; F16K 15/144

(57) ABSTRACT

A coffee pod can have a self-sealing lid with one more one-way valve elements that allow degassing. In low pressure environments, gases can escape from the coffee pod while inhibiting or preventing ingress of gases, such as oxygen. The self-sealing lid can be welded to a pod body and can be punctured by a brewing machine. In some embodiments, the one-way valve elements can include one or more gaskets, compressible layers, and/or valve members. In some embodiments, the lidding material and pod body cooperate to define one more one-way valve elements, which open and close upon stretching (e.g., outward bulging) of the lidding material.

### CROSS-REFERENCE TO RELATED APPLICATION

The present application claims the benefit of U.S. Provisional Patent Application No. 63/679,080, filed Aug. 2, 2024, the entire disclosure of which is herein incorporated by reference.

### TECHNICAL FIELD

The present technology relates generally to containers, and particularly to beverage pods with pressure relief valves and associated features, manufacturing equipment, and methods.

### BACKGROUND

Single-serve beverage machines, such as the widely recognized Keurig® brewing machines, have gained popularity for their ease of use, convenience, and ability to offer a variety of beverage options. The brewing machines deliver hot water into beverage pods to brew coffee, tea, and other drinks. Unfortunately, conventional beverage pods can explode, rupture, or bulge in low pressure environments (e.g., environments at high elevation locations). High-temperature environments present additional challenges for beverage pods because elevated temperatures can increase internal gas pressures in the beverage pods and can cause the materials of beverage pods, such as plastic and foil, to become more pliable and less structurally sound. This can lead to deformation of the beverage pods, rupture of the pod before the brewing process, etc. Accordingly, there is a need for solutions that enable beverage pod performance in a wide range of environmental conditions.

### BRIEF DESCRIPTION OF THE DRAWINGS

FIG. 1 is an isometric view of a beverage pod and a beverage brewing system in accordance with at least some embodiments of the present technology.

FIG. 2 is an isometric view of the beverage pod configured for automatic degassing in accordance with at least some embodiments of the present technology.

FIG. 3 is a top view of the beverage pod of FIG. 2.

FIG. 3A depicts a top detailed view of the beverage pod with an annular welded region configured in accordance with at least some embodiments of the present technology.

FIG. 3B depicts a top detailed view of a beverage pod with a welded region configured in accordance with at least some embodiments of the present technology.

FIG. 4 is a cross-sectional view of the beverage pod taken along a line 4-4 of FIG. 3.

FIG. 5 is a detailed view of a portion of the beverage pod of FIG. 4 with a pressure relief valve in a closed state in accordance with at least some embodiments of the present technology.

FIG. 6 is a detailed view of the portion of the beverage pod of FIG. 4 with the pressure relief valve in an open state in accordance with at least some embodiments of the present technology.

FIG. 7 shows a pressure relief forming element in accordance with at least some embodiments of the present technology.

FIG. 8 shows a welding head in accordance with at least some embodiments of the present technology.

FIG. 9 is a detailed view of pressure relief forming element of the welding head of FIG. 8.

FIGS. 10 and 11 show a manufacturing process in accordance with at least some embodiments of the present technology.

FIG. 12 is a side view of stacked beverage pods configured in accordance with at least some embodiments of the present technology.

FIG. 13 is a cross-sectional view of the stacked beverage pods of FIG. 12 in accordance with at least some embodiments of the present technology.

FIG. 14 is a detailed cross-sectional view of the stacked beverage pods of FIG. 13 with a pressure relief valve allowing degassing in accordance with at least some embodiments of the present technology.

FIG. 15 is a cross-sectional view of a beverage pod with pressure relief membranes in accordance with at least some embodiments of the present technology.

FIG. 16 is a cross-sectional view of a beverage pod with a sealing member in accordance with at least some embodiments of the present technology.

FIG. 17 is a cross-sectional view of a beverage pod with a frangible member in accordance with at least some embodiments of the present technology.

FIG. 18 shows a cross-sectional view of a relief valve of FIG. 17 in an open state.

FIG. 19 is a side view of the beverage brewing system with a lid in a pod loading position in accordance with at least some embodiments of the present technology.

FIG. 20 is a cross-sectional view of the beverage brewing system taken along a first sectional plane 20-20 of FIG. 19 in accordance with at least some embodiments of the present technology.

FIG. 21 is a cross-sectional detailed view of the beverage brewing system of FIG. 20 with the lid in a lowered brewing position in accordance with at least some embodiments of the present technology.

A person skilled in the relevant art will understand that the features shown in the drawings are for purposes of illustrations, and variations, including different and/or additional features and arrangements thereof, are possible.

### DETAILED DESCRIPTION

Embodiments of the present disclosure relate to containers configured for automatic degassing by, for example, releasing internal fluids to, for example, inhibit or prevent failure (e.g., exploding, rupturing, tearing, etc.), bulging, and/or impaired performance. The container can be a beverage pod (e.g., coffee beverage pod, tea beverage pod, K-cup, etc.), a dairy container (e.g., yogurt cup), foodstuff container, or the like. Conventional beverage pods can experience rupture or bulging in low pressure environments (e.g., environments at high elevation locations), high-temperature environments, or the like. Elevated temperatures can increase internal gas pressures in the beverage pods and can cause the materials used in the construction of beverage pods, such as plastic and foil, to become more pliable and less structurally sound. This can lead to deformation of the beverage pods, increasing the likelihood of rupture before the brewing process. For example, if the internal pressure reaches sufficiently high pressure, the structure integrity of the pod can be compromised, rendering the pod unsuitable for brewing. If the internal pressure reaches a rupture pressure, the pod can rupture such that contents of the pod are released and the ingress of environment gases. If brewing is attempted with the brewing pod, brewing liquid may not flow correctly through the pod and can spill out of the pod and/or the brewing machine. In some embodiments, the present disclosure relates to beverage pods that selectively release gases to keep internal pressures at or below a threshold pressure level. The beverage pods can include one or more pressure relief valves configured to release gases, for example, when the pressure inside the beverage pod is above a threshold pressure level, when a pressure differential between a pressure inside the beverage pod and the surrounding pressure exceeds a threshold pressure differential, or the like.

In some embodiments, a beverage pod can have a self-sealing lid with one more one-way valve elements that allow degassing. In low pressure environments, gases can escape from the coffee pod while inhibiting or preventing ingress of gases, such as oxygen. The self-scaling lid can be welded to a pod body and can be punctured by a brewing machine. In some embodiments, the one-way valve elements can include one or more gaskets, compressible layers, and/or valve members. In some embodiments, the lidding material and pod body cooperate to define one more one-way valve elements, which open and close upon stretching (e.g., outward bulging) of the lidding material.

In some implementations, a pressure inside a beverage pod can be increased due to high temperatures, such as temperatures at or above 100° F., 110° F., 120° F., 130° F., 140° F., 150° F., or the like. These temperatures can occur, for example, during shipment, storage, etc. The increased temperature can cause expansion of the gas (e.g., insert gases, nitrogen, CO2, air, etc.) inside of the beverage pod, which causes bulging of the pod. The bulging (e.g., bulging of a lid or foil covering) allows for degassing, thereby lowering pressure until the bulging is reduced (e.g., reduced to prevent pod rupture) or ceases. In this manner, the beverage pod can control internal pressures.

In some implementations, the beverage pod can include one or more pressure relief valves that allow the escape of gas to prevent excessive internal pressures from being reached. The pressure relief valves can be formed by a pod body and a lidding. For example, the lidding can include one or more perforations that allow egress of gas when the lidding is pushed away from an underlying region (e.g., a rim, a flange, etc.) of the pod body. When the lidding is pushed against the underlying region by external pressure (e.g., atmospheric pressure), the perforations can be closed or blocked. In some embodiments, the pressure relief valves can include one or more duck-bill valves, check valves, diaphragm valves and can be incorporated into or coupled to lidding of the pod, a main body of the pod, etc. The number, configuration, and locations of the pressure relief valves can be selected based on conditions (e.g., temperature, pressure, etc.) of the environment.

In some implementations, a beverage pod can include one or more degassing valves that operate automatically based on gas pressure inside of the pod. When the gas pressure is low, the beverage pod can be sealed to prevent the ingress/egress of gases. When the gas pressure is high, the beverage pod can allow the egress of gas(es). In some embodiments, the beverage pod includes multiple valves that open at a threshold egress pressure to allow egress of gas(es). When the internal pressure of the pod falls below the threshold egress pressure, the multiple valves can close, thereby hermetically resealing the pod. In some embodiments, the beverage pod includes multiple valves that open at respective threshold egress pressures (or threshold pressure differential) to allow egress of gas(es) at different pressures and flow rates. The threshold egress pressure (or threshold pressure differential) can be, for example, less than the rupture pressure for the pod, thereby protecting the integrity of the pod when excess pressure is applied to the pod, when the pod is in low pressure environments, etc.

The degassing valves can include one or more valves (e.g., one-way valves), membranes, sealing members, flow restrictors, frangible members, etc. The membranes can be selectively permeable (e.g., gas permeable and liquid impermeable) such that gas can flow through the valve while liquid cannot. This allows degassing while the pod remains liquid tight to inhibit, limit, or prevent liquid from escaping the pod during the brewing process. In some embodiments, the membranes are frangible membranes configured to rupture at a membrane rupture pressure. The degassing valves can be formed by components of the pod (e.g., rim and lidding), integrally formed in the pod, a valve coupled a body or lidding of the pod, or the like. In some embodiments, the valve is a pressure relief rim weld configured to allow fluid flow at the periphery of the pod. The fluid can exit a region of the pod that is uncovered by another pod stacked on top of the pod. In some implementations, the pressure relief rim weld can selectively control ingress/egress of gases. For example, the rim weld can allow egress of gases and inhibit or prevent ingress of external gases. In some embodiments, the beverage pod can include a perforated lid that forms part of the rim weld. The gas can escape via the perforations that can be blocked, covered, or obstructed by the rim until a threshold pressure differential is reached.

In some implementations, the beverage pod can experience bulging caused by excessive pressure differentials due to the pod being located at low pressure environments, such as at high altitudes. Example high altitudes can be, for example, 5000 feet above sea level, 7000 feet above sea level, 10,000 feet above sea level, 12,000 feet above sea level, or the light. The pressure relief valves can be configured to allow egress of gases at high altitudes to prevent excessive bulging or damage to the beverage pod. The pressure relief valves can be one-way valves configured to allow egress of gases well limiting, inhibiting, or substantially preventing ingress of gases, thereby preventing damage of the beverage pod.

In some implementations, the beverage pod may experience expansion or bulging when exposed to environments with reduced atmospheric pressure, such as during air transport or at high altitude locations. The interior chamber of the beverage pod may be initially sealed at or near sea level atmospheric pressure, which can be approximately 101 kPa (14.7 psi). When the sealed pod is subsequently transported to or stored at higher altitudes where atmospheric pressure is significantly lower, a pressure differential develops between the fixed internal pressure and the reduced external pressure. For example, at 10,000 feet above sea level, atmospheric pressure may drop to approximately 69.7 kPa (10.1 psi), creating a pressure differential of about 31.3 kPa (4.5 psi) that pushes outward on the pod walls and lidding. This pressure differential can cause the flexible portions of the pod, particularly the lidding material, to bulge outward as the higher internal pressure seeks to equalize with the lower external pressure.

The degree of expansion or bulging may be influenced by various factors including the initial sealing pressure, the magnitude of the external pressure reduction, the flexibility and strength of the pod materials, and the temperature conditions. In some cases, the bulging may be sufficient to compromise the structural integrity of the pod or interfere with proper insertion into brewing machines. The pressure relief valves disclosed herein may be configured to activate when the pressure differential exceeds a predetermined threshold, allowing controlled release of internal gases to reduce the pressure differential and minimize bulging. This controlled degassing process may help maintain the pod's structural integrity while preserving the internal environment needed to protect the beverage material from degradation due to exposure to external gases such as oxygen.

In some embodiments, a coffee pod can have a self-sealing lid with one or more one-way valve elements configured to allow degassing. In low pressure environments, gases can escape from the coffee pod while inhibiting or preventing ingress of gases (e.g., oxygen). The self-sealing lid can be welded or otherwise coupled to a pod body and can be punctured by a brewing machine. In some embodiments, the one-way valve elements can include through-holes, gaskets, compressible layers, and/or valve members. In some embodiments, the lidding material and pod body cooperate to define one more one-way valve elements, which open and close upon stretching (e.g., outward bulging) of the lidding material. The one-way valve elements can open and close repeated to limit a pressure differential between the internal pressure in the pod and the surrounding environment.

In some embodiments, a container includes a perforated lid that moves away from or towards a container body to correspondingly open and close the perforations. The perforations can be positioned along a rim of the container body. When the pressure inside the container exceeds a threshold pressure, the lidding can move away from the rim. This can create flow channels underneath the lid such that fluid can flow underneath the lid and through the perforations. The lid can remain attached to the container body during this process. As the pressure inside the container is decreased, the lid can move back towards the rim until the lid reseals with the rim. The seal can be a fluid-tight seal and/or airtight seal. In this manner, the container automatically allows for one directional flow for degassing while inhibiting, limiting, or substantially preventing the ingress of gases. In some implementations, the perforations can be through holes evenly or unevenly spaced about the periphery of the lidding. The perforations can have a tapered passageway, uniform width passageway, or the like. In some implementations, the container can be in the form of a beverage pod (e.g., K-cup), dairy container (e.g., single serve yogurt container), or other containers for food stuff.

In some embodiments, a container includes a perforated lid that moves away from or towards a container body to correspondingly open and close the perforations. The preparations can be positioned along a rim of the container body. When the pressure inside container exceeds the threshold pressure, the lidding can move away from the rim. This can create flow channels underneath the lid such that fluid can flow underneath the lid and through the perforations. The lid can remain attached to the container body during this process. As the pressure inside the container is decreased, the lid can move back towards the rim until the lid reseals with a rim. The seal can be a fluid tight or airtight seal. In this manner, the container automatically allows for one directional flow for degassing while inhibiting, limiting, or substantially preventing egress of gases.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

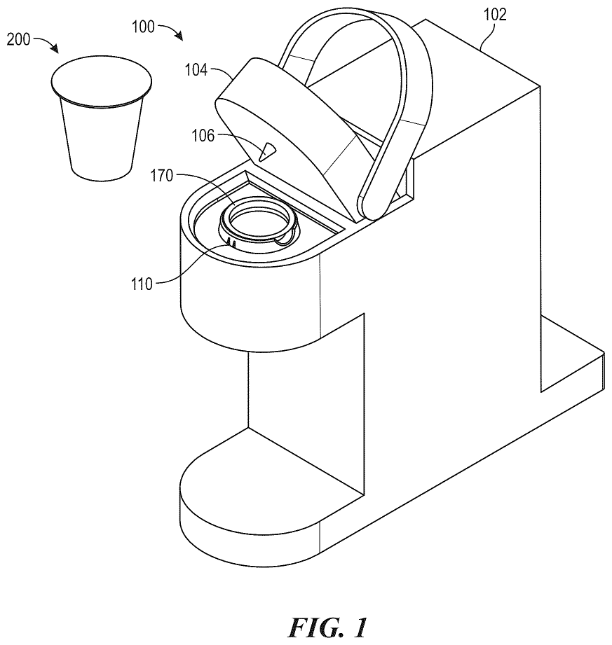

FIG. 1 is an isometric view of a beverage pod 200 and a beverage brewing system 100 configured in accordance with embodiments of the present technology. The beverage brewing system 100 can include a beverage brewing machine 102, an adaptive housing or pod holder 110, and a beverage pod 170. The beverage pod 200 can be inserted into the beverage brewing system 100 to brew a beverage, such as coffee, tea eat. The beverage pod can experience bulging due to excessive pressure differentials due to the pod being located at low pressure environments, such as at high altitudes. Example high altitudes can be, for example, 5000 feet above sea level, 7000 feet above sea level, 10,000 feet above sea level, 12,000 feet above sea level, or the like. Example atmospheric pressures can be 101 kPa at sea level, 78.2 kPa at 7,000 feet above sea level, 69.7 kPa at 10,000 feet above sea level, and 57.2 kPa at 15,000 feet above sea level. In some embodiments, high altitudes can be, for example, 5,000 meters above sea level, 7,000 meters above sea level, 10,000 meters above sea level, 12,000 meters above sea level, or the like. The atmospheric pressure can be, for example, 101 kPa, 58 kPa, 26 kPa, 20 kPa, etc. and depends on the altitude and temperature. In some embodiments, low pressure environments can be 0.7 atm, 0.5 atm, 0.4 atm, 0.3 atm, 0.2 atm, 0.1 atm, or the like. The configuration of the pod can be selected such that the structural integrity of the pod is not compromised in such low-pressure environments. The pad is designed to automatically facilitate degassing, thereby reducing pressure differentials, while simultaneously preventing a substantial amount of ambient air (which could compromise the integrity of the pod's contents) from entering the pod.

The beverage pod 200 can be configured for automatic degassing to prevent an adverse event (e.g., rupturing, exploding, etc.) of the pod 200. For example, the beverage pod 200 can include one or more pressure relief valves configured to allow egress of gases at high altitudes to prevent excessive bulging or damage to the beverage pod. The pressure relief valves can be one-way valves configured to allow egress of gases, as well limiting, inhibiting, or substantially preventing ingress of environmental gases (e.g., oxygen), thereby preventing damage of the beverage pod and/or degradation of the beverage material. If oxygen enters the pod (e.g., enters its internal chamber), the oxygen can slowly degrade (e.g., oxidize) the beverage material. The internal chamber of the pod 200 can remain hermetically sealed and filled with an inert gas(es) to maintain beverage material (e.g., coffee grounds, tea leaves, herbs, brewing ingredients, etc.) freshness and flavor. If inert gas(es) are selectively released from the chamber, the pod can automatically reseal after such release to limit or prevent external gases from entering the internal chamber. In this manner, the inert environment in the internal chamber can be maintained throughout one or more degassing events.

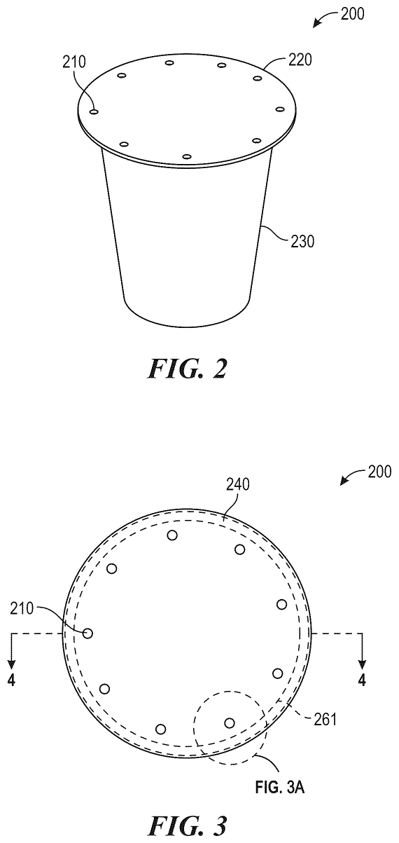

FIG. 2 is an isometric view of the beverage pod 200 configured for automated degassing in accordance with at least some embodiments of the present technology. The beverage pod 200 can include a lid 220 (also referred to as “lidding”) and a pod body 230. The lid 220 can cooperate to form the pressure relief valve 210 (one identified) configured to allow controlled degassing while maintaining the hermetically sealed state of the interior chamber containing beverage material.

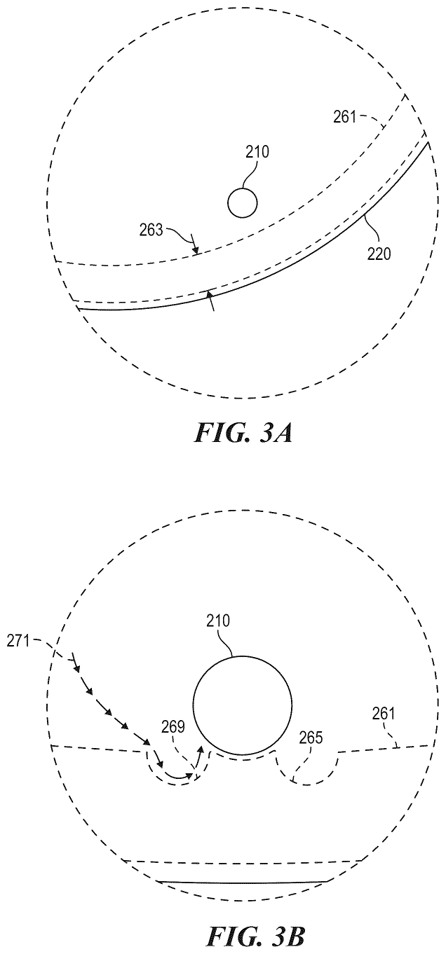

FIG. 3 is a top view of the beverage pod 200 of FIG. 2. The number and positions of the pressure relief valves can be selected based on the configuration of the beverage pod 200. For example, a central region 240 of the lidding 220 can be configured to be punctured by a brewing needle. The pressure relief valves 210 can surround the central region 240 such that the brewing needle is spaced apart from the pressure relief valves 210 during use. The description of one of the pressure relief valves applies to the others unless indicated otherwise.

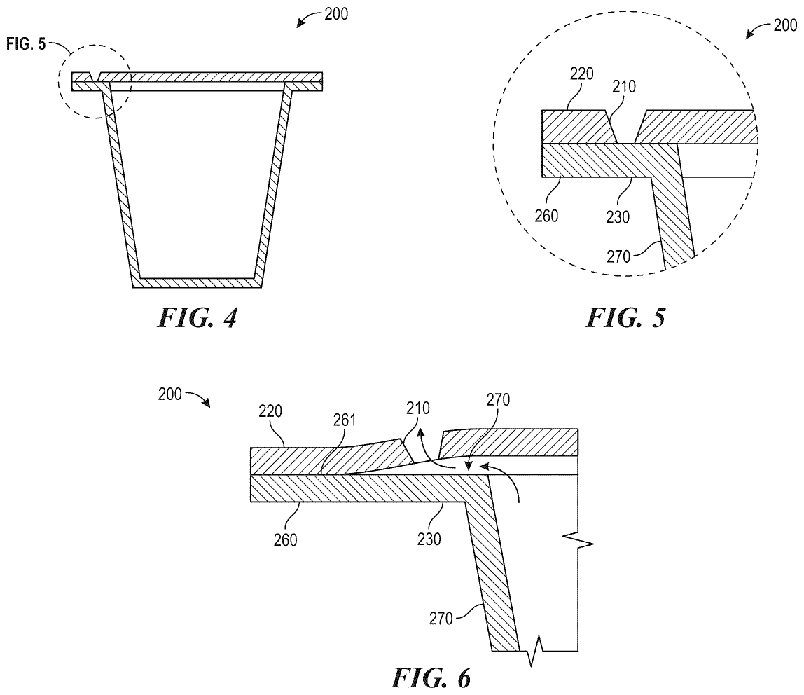

The beverage pod 200 has a welded region 261 connecting the lidding 220 to the rim 260. The welded region 261 can be an annular thermal weld surrounding the pressure relief valves 210. Referring now to FIG. 3A, the welded region 261 can have an annular shape and can be adjacent to or spaced apart from the relief valves 210. In some embodiments, a width 263 of the welded region 261 can be uniform or variable along the periphery of the lidding 220. The width 263 can be equal to or greater than 1 mm, 2 mm, 4 mm, 5 mm, 7 mm, 10 mm, or the like. In some embodiments, the welded region 261 can be spaced apart from the pressure relief valve 210 to allow movement of the lidding 220 from the underlying rim, as discussed in connection with FIGS. 4-6 and 14-18. In some embodiments, the welded region 261 can be formed by one or more adhesives that couple the lidding 220 to the underlying rim 260. The connection, materials, configuration of the interfaces and/or connections can be selected based on the desired coupling between components of the pod 200.

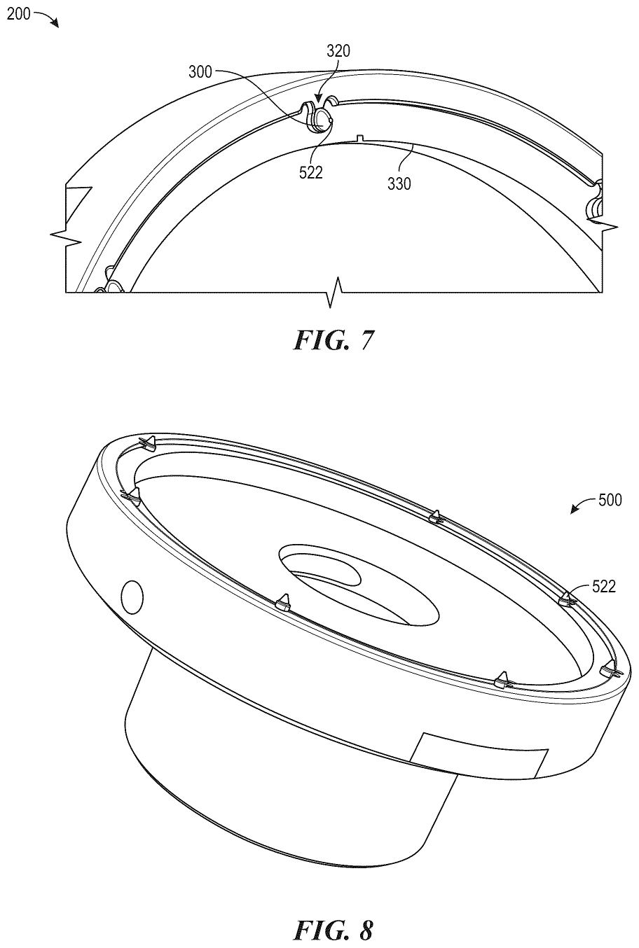

Referring now to FIG. 3B, the welded region 261 can have a configuration for allowing operation of the pressure relief valve 210 while inhibiting, preventing, limiting, or substantially preventing unintentional escaping of air. For example, the welded region 261 can include a necked region 265 extending towards a pressure relief valve 210. When the pressure relief valve 210 is open, the necked region 265 can prevent or limit delamination between the adjacent region of the lidding 220. In some embodiments, the necked region 265 can include flow directing regions 269 for directing controlled gas flow towards the pressure relief valve 210, as indicated by arrows 271. The welded region 261 of FIG. 3B can be formed using the welding head 500 as discussed in connection with FIGS. 7-9.

FIG. 4 is a cross-sectional view of the beverage pod 200 taken along a line 4-4 of FIG. 3. FIG. 5 is a detailed view of a portion of the beverage pod of FIG. 4 with the pressure relief valve 210 in a closed state in accordance with at least some embodiments of the present technology. FIG. 6 is a detailed view of the portion of the beverage pod 200 of FIG. 4 with the pressure relief valve 210 in an open state in accordance with at least some embodiments of the present technology. Referring to FIGS. 5 and 6, the lidding 220 can be connected to a rim 260 of the pod body 230. In some embodiments, the rim 260 can be a flange or cantilevered region having a width equal to or greater than, for example, 2 mm, 4 mm, 5 mm, or the like and a thickness equal to or less than 0.2 mm, 0.5 mm, 1 mm, or the like. In some embodiments, the rim 260 can be coupled (e.g., adhered, welded, ultrasonically welded, etc.) to the lidding 220. For example, a welded region 261 of FIGS. 3 and 6 (e.g., a thermal weld) can connect a rim 260 and the lidding 220. The welded region 261 can be an annular thermal weld surrounding the pressure relief valves 210.

When the pressure differential between the inside of the beverage pod 200 and the external environment exceeds the threshold level, the lidding 220 can move away from the pod body 230, as shown in FIG. 6. This allows a flow channel or path 270 to be defined between the interior region and the pressure relief valve 210. Gas can flow along the path 270, through the pressure relief valve 210, and out the beverage pod 200. As the pressure differential is reduced, the bulging portion of the lidding 220 can move downwardly against the upper surface of the rim 260, thereby forming a seal (e.g., an air-tight seal, a liquid-tight seal, etc.) to close the pressure relief valve 210. In this manner, the pressure relief valve 210 can be repeatedly opened for egress of gases and closed for inhibiting or prevent egress of gases.

The pressure relief valve 210 can include a through hole (e.g., a tapered through hole, a uniform width through hole, etc.), one-way or two-way permeable membranes, or the like. In some embodiments, the lidding 220 can include a pattern of perforations that cooperate to form pressure relief valves. The pattern can be selected based on the brewing process to be performed. Additionally or alternatively, one or more sealing elements (e.g., gaskets, compressible layers, etc.) can surround or be adjacent to be adjacent to the pressure relief valve to facilitate resealing of the pressure relief valve 210.

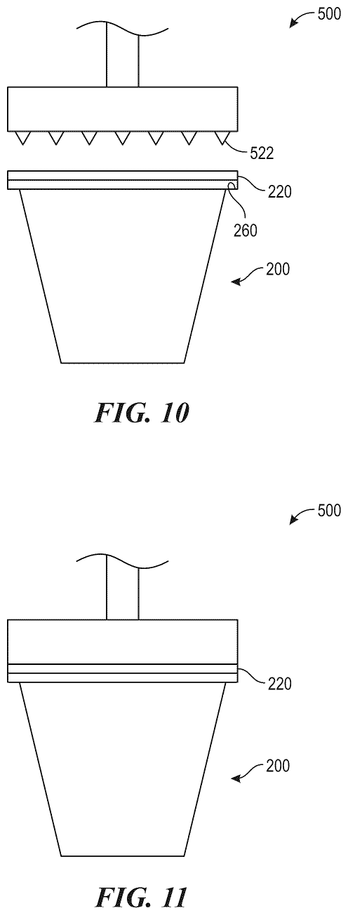

FIG. 7 shows a pressure relief forming element 522 in accordance with at least some embodiments of the present technology. The pressure relief forming element 522 can include a through hole forming portion 300, which can be a piercing member, a cone, a frusto-conical member, a pyramidal member, blade shaped, or the like. The forming portion 300 can be configured to pierce lidding without piercing the underlying rim. For example, the lidding can be pierced and then welded to the rim, as discussed in connection with FIGS. 10 and 11. The pressure relief forming element 522 can include a through hole 300, a gas-escape channel 320, and a raised portion 330 configured to maintain a distance between the through hole 300 and a surface of a brewing machine, packaging, etc.

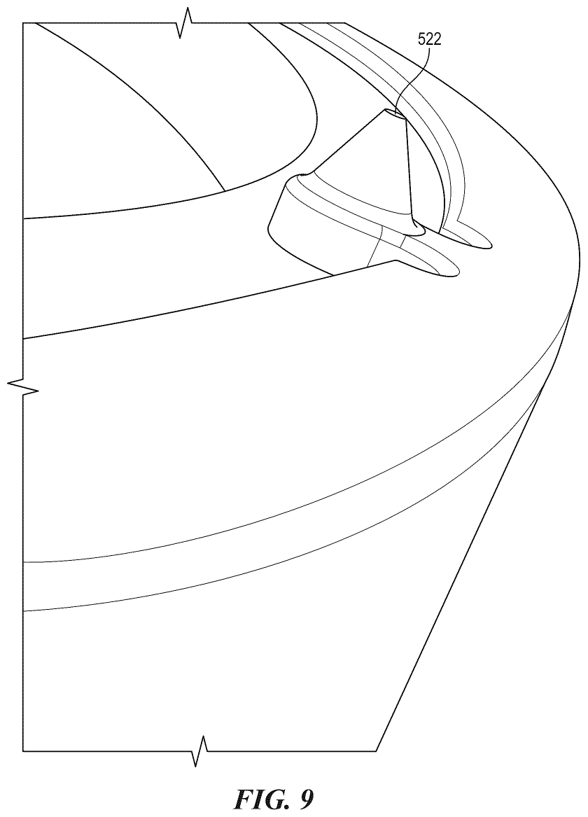

FIGS. 8 and 9 show a welding head 500 in accordance with at least some embodiments of the present technology. The welding head 500 can include a plurality of pressure relief forming elements 522 (one identified) configured to form pressure relief valves before and/or during assembly of the lidding 220 to the pod body 230. In some embodiments, the welding head 500 concurrently forms the through hole, a gas escape channel, and other features of the pod.

FIGS. 10 and 11 show a manufacturing process in accordance with at least some embodiments of the present technology. Referring now to FIG. 10, the welding head 500 can be moved towards the beverage pod 200. The pressure relief valve forming elements 522 can be moved toward and through the lidding 220. The welding head 500 can output energy for welding the bottom surface of the lidding 220 to the beverage pod body 230. The manufacturing process can be selected based on the configuration and composition of the beverage pod 200. In some embodiments, the lidding 220 can be pressed onto the welding head 500 prior to placement on the pod body 230 to pre-form the openings. The welding head 500 can then move towards the pod body 230 to position the lidding 220 onto the rim 260. In some embodiments, the rim 260 deflects to allow piercing of the lidding 220 without puncture of the rim 260. The welding head 500 can then thermally weld the lidding 220 to the rim 260. In some embodiments, the welding head 500 can then thermally weld the lidding 220 to the rim 260 while the pressure relief valve forming elements 522 extend through the lidding 220.

The beverage pod 200 can be made, in whole or in part, of thermoplastic polymers, such as polypropylene (PP), polyethylene (PE), or polystyrene (PS). This allows it to serve as a biodegradable alternative for coffee pods. In some examples, the pod exterior can also be made from polyhydroxyalkanoates (PHAs), which are a biodegradable polyester produced through bacterial fermentation of sugar or lipids. The pod exterior can be used as alternatives to other synthetic plastics. The mechanical properties of PHAs can be modified for a given use case by blending it with other biodegradable polymers, such as PLAs. They can also be made from poly (L-lactide) (PLLA), which is a polymer that is also biodegradable and compostable. The material can be used to form various aspects of the beverage pod. PLLA is also readily renewable, often made from fermented plant starch such as from corn, cassava, sugarcane, or sugar beet pulp. Cellulose fibers are fibrous materials made from plant materials such cotton, flax, wood pulp, etc. Cellulose fibers can provide a biodegradable filter material that could be used in coffee pods. Other materials that are biodegradable plastic alternatives include petroleum-based plastics such as, Polyglycolic acid (PGA), Polybutylene succinate (PBS), Polycaprolactone (PCL), Polyvinyl alcohol (PVOH), and/or Polybutylene adipate terephthalate (PBAT). Beverage pods, beverage capsules, and components made, in whole or in part of, materials disclosed in U.S. application Ser. No. 17/327,330 (US Pub. No. 20210362941) filed Jan. 5, 2021; Ser. No. 17/570,188 (US Pub. No. 20220234773) filed Jan. 6, 2022; U.S. application Ser. No. 17/748,995 (US Pub. No. 20230110106) filed Jan. 19, 2023, which are incorporated by reference in their entireties. Example auxiliary components, features, and methods are disclosed in U.S. application Ser. No. 15/135,808 (US Pub. No. 20160325898); US App. No. 1515/414,587 (US Pub. No. 20180206667); U.S. application Ser. No. 15/589,743; U.S. application Ser. No. 17/369,641 (US Pub. No. 20210401219); U.S. application Ser. No. 17/375,884 (US Pub. No. 20220017294); PCT Pub. No. WO2021226582; PCT Pub. No. WO2022013792; U.S. application Ser. No. 17/316,135 (US Pub. No. 20210347558); U.S. application Ser. No. 17/323,431 (US Pub. No. 20210354405); U.S. application Ser. No. 17/327,330 (US Pub. No. 20210362941); U.S. application Ser. No. 17/344,541 (US Pub. No. 20210386237); U.S. application Ser. No. 17/346,934 (US Pub. No. 20210386236); U.S. application Ser. No. 17/570,189 (US Pub. No. 20220234774); U.S. application Ser. No. 17/570,188 (US Pub. No. 20220234773); U.S. application Ser. No. 17/570,182 (US Pub. No. 20220234772); U.S. application Ser. No. 17/694,285 (US Pub. No. 20220287494); and U.S. application Ser. No. 17/694,342 (US Pub. No. 20220288828); U.S. application Ser. No. 17/748,993 (US Pub. No. 20230111111); and U.S. application Ser. No. 17/748,995 (US Pub. No. 20230110106), which are all incorporated by reference in their entireties. The beverage pods can include auxiliary components, such as filter elements, plates, registration elements, etc. For example, the lower portion of the pod 200 can include one or more filters (e.g., a planar filter, a bag filter, a mesh filter, etc.) that fit inside the interior chamber. One or more filter guards can also be positioned to lay across the lower brewing pin. This allows for beverage materials to be retained in the lower portion. For example, the first beverage material can be coffee grounds. The second beverage material can be in the form of tea leaves. This allows for the coffee grounds and tea leaves to be retained in the beverage capsule pod 200 to brew a tea-infused coffee beverage. In other embodiments, the lower portion can release the second beverage material. For example, a liquid, a powder, or other beverage ingredient can be held in the lower portion. When the brewing needle accesses the lower portion, the second beverage material can fall unobstructed out of the lower portion. This allows for convenient releasing of most (e.g., most by volume or weight), substantially all, (e.g., substantially all by volume or weight), or the entire contents of the lower portion.

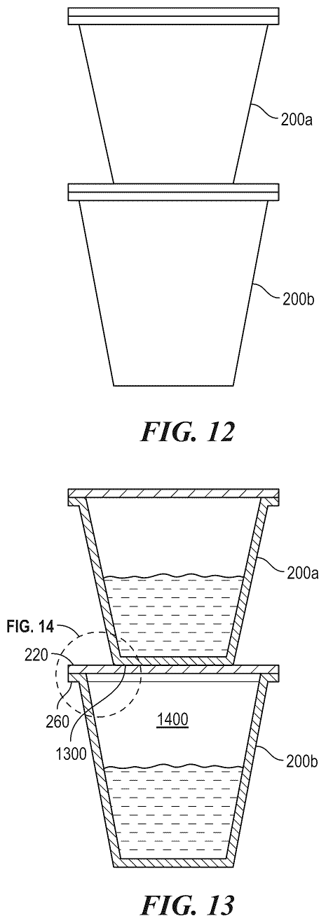

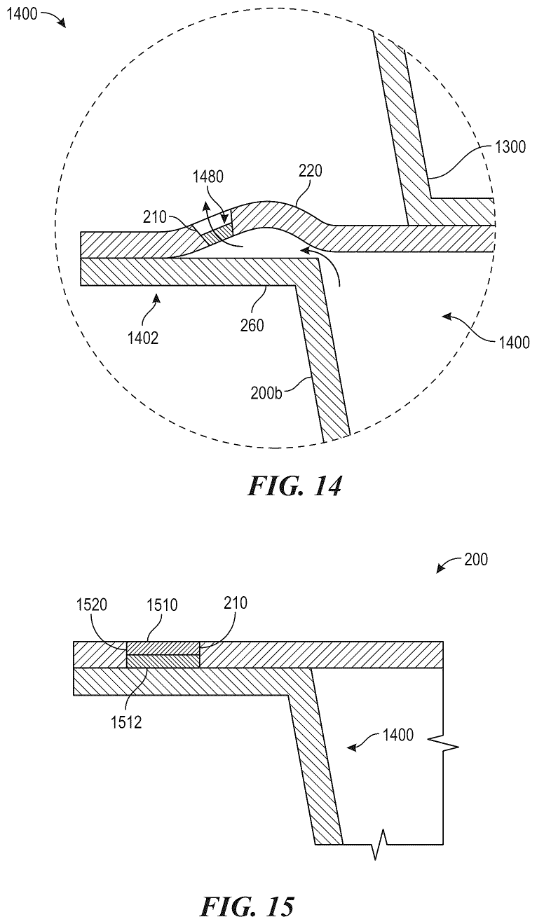

FIG. 12 is a side view of stacked beverage pods 200a, 200b (collectively, “beverage pods 200”). The upper beverage pod 200a can rest upon central region of lower beverage pod 200b. The relief valves of the lower beverage pod 200b remain uncovered to allow for degassing. The beverage pods 200 can be stacked in different arrangements. The beverage pods can experience different ambient pressures and can automatically degas during transport and/or storage. An example of degassing occurring with stacked pods is discussed in connection with FIGS. 13 and 14.

FIG. 13 is a cross-sectional view of portions of the beverage pods 200a, 200b. FIG. 14 is a detailed view of the pressure relief valve in a degassing open state. Referring now to FIG. 13, a flat surface of a tapered bottom 1300 of the beverage pod 200a can rest upon lidding 220 of the pod 200b. The periphery of the bottom 1300 can be spaced inwardly of the rim 260. The periphery of the bottom 1300 can also be positioned inwardly of relief valves located on the rim 260 (FIG. 13). This allows a portion of the lidding 220 between the bottom 1300 and the rim 260 to bulge upwardly for degassing.

Referring now to FIG. 14, when a sufficient pressure differential exists between the interior chamber 1400 of the pod 200b and the ambient environment 1402, the inert gas located in the chamber 1400 can push upwardly on the lidding 220. The bottom 1300 of the upper pod 200a can rest stably on the lidding 220 while gas (e.g., inert gas), as indicated by arrows, can flow between the lidding 220 and the rim 260. The gas can flow between along a gap between the lidding 220 and rim 260 and exit the relief valve 210. In this manner, the beverage pods 200 can remain in a stacked configuration before, during, and/or after the degassing process. After the pressure differential is sufficiently reduced, the weight of the pod 200a, surrounding air pressure, and/or tensioning of the lidding 220 can close the gap between the lidding 220 and the rim 260. This can help reseal the relief valve 210, thereby preventing egress of ambient gases. This process can be repeated any number of times to allow degassing during, for example, transport, storage at a user's residence, when displayed at stores, or the like.

The relief valve 210 can include one or more flow elements 1480 that can, for example, limit or prevent egress or ingress of fluids. For example, the flow element 1480 can be a membrane that extends across an opening (e.g., a through hole) of the relief valve 210 (not shown in FIG. 13) and can be air permeable and fluid impermeable. This allows gases to escape the pod 200b while preventing the escape of liquids during the brewing process. Accordingly, the pod 200b can be a degassing liquid-tight pod. The configuration and features of the pod can be selected to allow different types of fluids allowed to escape based on the brewing process.

FIGS. 15-17 show example embodiments of relief valves that can be used with the beverage pods disclosed herein. FIG. 15 is a cross-sectional view of a relief valve 210 that includes a plurality of membranes 1510, 1512 positioned in an opening 1520. The membranes 1510, 1512 can be air permeable membranes, fluid impermeable membranes, or the like. For example, the membrane 1512 can be a gas permeable and fluid impermeable membrane. The membrane 1510 can be impermeable to ambient air while being permeable to inert gases. This allows for one-way flow out of the interior chamber 1400 of the pod 200.

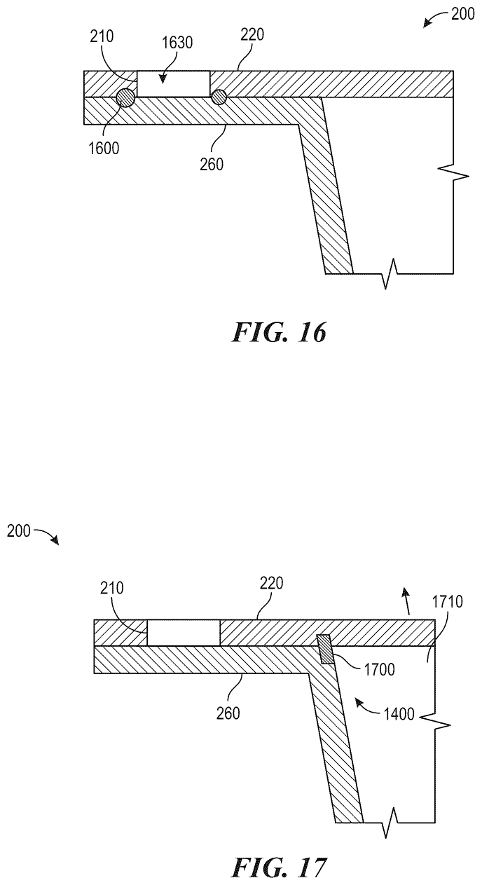

FIG. 16 is a cross-sectional view of the pod 200 with a gas relief valve 210 including one or more sealing members 1600. The sealing member 1600 can include, for example, one or more gaskets, sealing rings, compressible members, or elements for facilitating the formation of desired seals (e.g., fluid tight seals, air-tight seals, liquid-tight seals, frangible seals, etc.) along the interface between lidding 220 and the rim 260. In some embodiments, the sealing member 1600 is an O-ring that surrounds the opening 1630 in the lidding 220. In some embodiments, the sealing ring 1600 is integrated into or coupled to the lidding 220. In other embodiments, the sealing member 1600 is integrated into or coupled to the rim 260. The position, configuration, and number of the scaling rings 1600 can be selected based on the desired sealing capabilities of the relief valves 210. Additionally, one or more optional flow elements (e.g., one-way valves, two-way valves, membranes, or the like) can be positioned in the opening 1630. The combination of components forming the one-way valve 210 can be selected based on the desired egress and ingress of fluids.

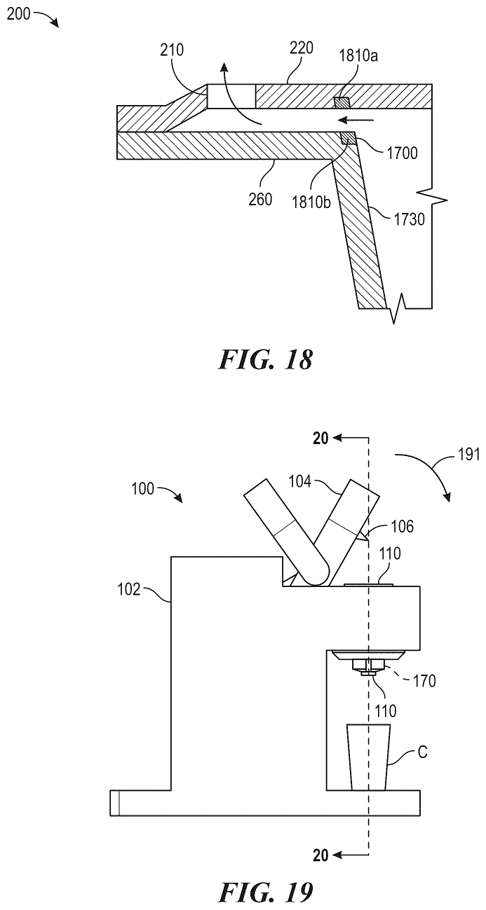

FIG. 17 is a cross-sectional view of a relief valve 210 in a closed position in accordance with another embodiment. FIG. 18 is a cross-sectional view of the relief valve 210 in an open position. Referring now to FIG. 17, the beverage pod 200 can include a frangible sealing member 1700 that can be broken to allow egress of gases. The frangible member 1700 can form a seal at the upper region (e.g., interface of the lidding and pod body) of the chamber 1400. When the lidding 220 is pushed upwardly, as indicated by arrow 1710, the frangible member 1700 can break at a desired location, such as along the interface between the rim 260 and the lidding 220. FIG. 18 shows the broken frangible member 1700 with an upper portion 1810a retained by the lidding 220 and a lower portion 1810b retained by a body 1730 of the pod 200. As indicated by the arrows, the inert gas can flow past the broken frangible member 1700, between the lidding 220 and the rim 260, and exit the relief valve 210.

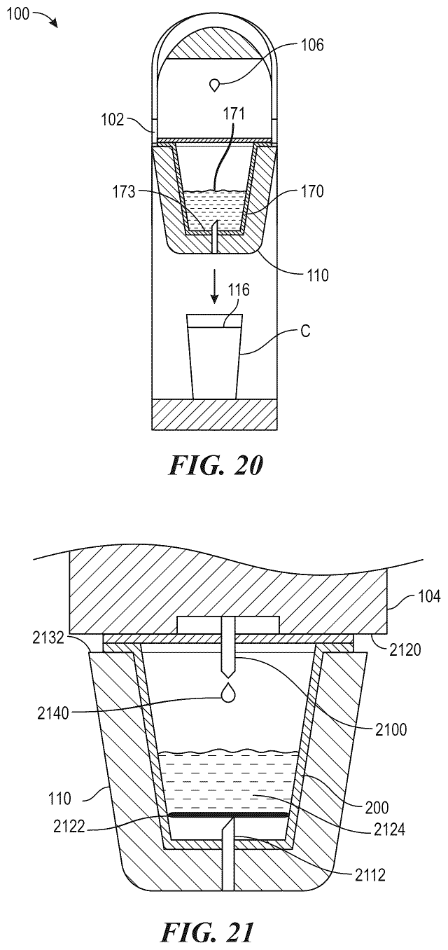

FIG. 19 is a side view of the beverage brewing system 100. FIG. 20 is a cross-sectional view of the beverage brewing system 100 taken along a first sectional plane 20-20 shown in FIG. 19. The first sectional plane 20-20 can correspond to a longitudinal plane of the pod holder 110 and/or the beverage pod 170. FIG. 21 is a side view of the beverage pod 200 located in the beverage brewing system 100.

Referring to FIGS. 19-20 together, the beverage brewing system 100 includes the beverage pod 170 disposed inside the pod holder 110, which is disposed inside the beverage brewing machine 102. Both the beverage pod 170 and the pod holder 110 are positioned above a cup C placed on the beverage brewing machine 102. In operation, a user can close the lid 104 (as indicated by arrow 191) to push down on the beverage pod 170, causing the puncture element 106 to pierce a lidding (e.g., mono or multi-layer film) of the beverage pod 170, and first and second needles to pierce additional lidding. As shown in FIG. 20, the beverage pod 170 is directly above the cup C such that the ingredients can flow into the cup C (illustrated by beverage level 116). The lower portion of the beverage pod 170 is configured to contain a sufficient amount of a first beverage material 173 that is at a temperature equal to or higher than a sanitization temperature (e.g., 90 degrees Celsius, 100 degrees Celsius, 110 degrees Celsius, 110 degrees Celsius, etc.) for lower brewing pin sanitization. In some sanitized brewing processes, the beverage pod 170 can contain a sufficient amount (e.g., 1 fluid ounce, 1.5 fluid ounces, 2 fluid ounces, 2.5 fluid ounces, 3 fluid ounces, 4 fluid ounces, etc.) of the heated liquid/beverage for brewing pin sanitization. For example, all or most of the beverage-contacting portions of the brewing pins contacting foodstuff (e.g., heated liquid, heated beverage, partially brewed beverage, etc.) can be submerged in the heated liquid/beverage, thereby sanitizing the beverage-contacting portions. The brewing pins can be partially or completely submerged for a sanitization period equal to or greater than at least 10 seconds, 20 seconds, 30 seconds, 45 seconds, 1 minute, 2 minutes, or the like. The lower portion of the beverage pod 170 can be configured to release substantially all (at least 70%, 80%, 90%, 95%, 98%, or 99% by weight or volume) of the contained beverage material prior to completion of delivery of the heated liquid into the beverage pod 170. In other embodiments, the beverage pod 170 can be used to perform non-sanitization brewing for cold or iced beverages.

In some embodiments, the beverage pod 170 includes coffee grounds 171, and a beverage liquid 173 (e.g., at least 1 fluid ounce, 1.5 fluid ounce, 2 fluid ounce, 3 fluid ounce, etc.) in the lower chamber. A filter or mesh can retain the coffee grounds in the upper chamber.

Referring to FIGS. 20-21 together, the beverage pod 200 is shown disposed inside a pod holder 110, which is disposed inside the beverage brewing machine 102. Both the beverage pod 200 and the pod holder 110 are positioned above a cup C placed on the beverage brewing machine 102. In operation, a user can close the lid 104 to push down on the beverage pod 170, causing the puncture element 106 to pierce lidding of the beverage pod 200.

Referring to FIGS. 20-21, the puncture element 106 can have a sharp distal portion 2100 configured to be positioned in an interior chamber of the pod 200. A filter or mesh can be positioned in the chamber to retain the coffee grounds in the chamber. A lower portion 2120 of the lid 104 can press downwardly on the periphery of the pod 200, thereby holding close the relief valves. For example, the lower portion 2120 and upper portion 2132 can compress the lidding/rim to prevent opening of the relief valves. In some embodiments, one or more gaskets can prevent or inhibit fluid flow between the pod 200 and the brewing machine 102.

The beverage pod 200, disposed inside a pod holder/basket 110, can include a capsule interior with integrated features to act as a filter guard, removing the requirement for a discrete filter guard. When the lower pin 2112 passes through the beverage pod 200, it can contact the bottom side of the filter guard 2122 (shown by bold line). The brewing pin 2112 can push the filter guard 2122 upwardly to form a gap through which fluid can flow. The beverage can flow around and underneath the filter guard 2122 and ultimately through the brewing pin 2112.

A filter guard 2122 can be a medium, such as spun bond PLA web, paper (cellulose), cloth or metal, that is used to prevent an insoluble beverage material from leaving the beverage pod and entering the beverage brewing machine or the beverage. The filter can be symmetrical (e.g., fluted), or asymmetrical (e.g., pleated). Beverage material is the material used to produce a brewed beverage, such as coffee grounds, tea, or a mix beverage where the beverage material is soluble, such as hot chocolate. Beverage material can include any flavorings, nutritional content (e.g., any oils, nutritional supplements, active ingredients such as pharmaceuticals, cannabinoids, etc.), alcohol, coloring, or any other composition which has an effect on the final beverage. Beverage brewing machines for brewing portioned beverages from pre-packed beverage pods exist for a variety of beverages made from a beverage material that is either insoluble, such as coffee, or soluble, such as hot chocolate.

Each of the compartment portions of the beverage pod 200 can include auxiliary components. Example auxiliary components, features, and methods are disclosed in U.S. application Ser. No. 15/135,808 (US Pub. No. 20160325898); US App. No. 1515/414,587 (US Pub. No. 20180206667); U.S. application Ser. No. 15/589,743; U.S. application Ser. No. 17/369,641 (US Pub. No. 20210401219); U.S. application Ser. No. 17/375,884 (US Pub. No. 20220017294); PCT Pub. No. WO2021226582; PCT Pub. No. WO2022013792; U.S. application Ser. No. 17/316,135 (US Pub. No. 20210347558); U.S. application Ser. No. 17/323,431 (US Pub. No. 20210354405); U.S. application Ser. No. 17/327,330 (US Pub. No. 20210362941); U.S. application Ser. No. 17/344,541 (US Pub. No. 20210386237); U.S. application Ser. No. 17/346,934 (US Pub. No. 20210386236); U.S. application Ser. No. 17/570,189 (US Pub. No. 20220234774); U.S. application Ser. No. 17/570,188 (US Pub. No. 20220234773); U.S. application Ser. No. 17/570,182 (US Pub. No. 20220234772); U.S. application Ser. No. 17/694,285 (US Pub. No. 20220287494); and U.S. application Ser. No. 17/694,342 (US Pub. No. 20220288828); U.S. application Ser. No. 17/748,993 (US Pub. No. 20230111111); and U.S. application Ser. No. 17/748,995 (US Pub. No. 20230110106), which are all incorporated by reference in their entireties. The auxiliary components can include filter elements, plates, registration elements, etc. For example, the lower portion of the beverage pod 200 can include the filter guard, filter elements, or the like. For example, the lower portion of the pod 200 can include one or more of the filter (e.g., a planar filter, a bag filter, a mesh filter, etc.) that fits inside the interior chamber. One or more filter guards can also be positioned to lay across the brewing pin 2112. This allows for beverage materials to be retained in the lower portion.

With recontinued reference to FIG. 21, a liquid 2140 (e.g., water, hot water, etc.) can flow out of the needle 106 and through brewing material 2124. An exit needle or pin 2112 can extend upwardly into the interior chamber such that brewed beverage can flow downwardly through the exit needle 2112 and into the cup C. The relief valves can remain closed during this brewing process.

Referring to FIGS. 19-21, the beverage brewing machine 102 can contain many components, such as, for example, a heating element, a liquid reservoir or plumbing component, a liquid pump, an exterior chassis, a controller for the brewing process, a display or indicator lights and sounds, a user interface including buttons or a touchscreen, a tray to catch spillage, etc. For the purposes of description, it is assumed a beverage brewing machine contains all components necessary to accomplish the beverage brewing process, though specific reference to beverage brewing machine components can only be made to those components which come into direct contact with the beverage pod, such as the brewing chamber, a fluid injecting component, and a fluid extracting component. A beverage brewing machine can contain the following elements: A beverage brewing machine can contain the following elements: A fluid source that supplies the liquid, usually water, to the brewing machine for producing the desired beverage, element. A brewing chamber lid that opens to allow a new pod to be added to the machine, and in many of the most common embodiments of a beverage brewing machine, the chamber lid contacts the fluid source to the brewing pin, but the fluid source does not have to be in the brewing chamber lid, element. A brewing pin member, or fluid injecting component 106, that typically has a piercing element to puncture the beverage pod lid, that provides a liquid, typically hot water, to mix with the beverage medium to create the beverage.

The embodiments, features, systems, devices, materials, methods and techniques described herein can, in some embodiments, be similar to any one or more of the embodiments, features, systems, devices, materials, methods and techniques described in the following: U.S. application Ser. No. 15/135,808 (US Pub. No. 20160325898); US App. No. 1515/414,587 (US Pub. No. 20180206667); U.S. application Ser. No. 15/589,743; U.S. application Ser. No. 17/369,641 (US Pub. No. 20210401219); U.S. application Ser. No. 17/375,884 (US Pub. No. 20220017294); PCT Pub. No. WO2021226582; PCT Pub. No. WO2022013792; U.S. application Ser. No. 17/316,135 (US Pub. No. 20210347558); U.S. application Ser. No. 17/323,431 (US Pub. No. 20210354405); U.S. application Ser. No. 17/327,330 (US Pub. No. 20210362941); U.S. application Ser. No. 17/344,541 (US Pub. No. 20210386237); U.S. application Ser. No. 17/346,934 (US Pub. No. 20210386236); U.S. application Ser. No. 17/570,189 (US Pub. No. 20220234774); U.S. application Ser. No. 17/570,188 (US Pub. No. 20220234773); U.S. application Ser. No. 17/570,182 (US Pub. No. 20220234772); U.S. application Ser. No. 17/694,285 (US Pub. No. 20220287494); and U.S. application Ser. No. 17/694,342 (US Pub. No. 20220288828); U.S. application Ser. No. 17/748,993 (US Pub. No. 20230111111); and U.S. application Ser. No. 17/748,995 (US Pub. No. 20230110106). All of the above-identified patents and applications are incorporated by reference in their entireties. In addition, the embodiments, features, systems, devices, materials, methods and techniques described herein can, in certain embodiments, be applied to or used in connection with any one or more of the embodiments, features, systems, devices, or other matter.

It will be apparent to those having skill in the art that changes can be made to the details of the above-described embodiments without departing from the underlying principles of the present disclosure. In some cases, well known structures and functions have not been shown or described in detail to avoid unnecessarily obscuring the description of the embodiments of the present technology. Although steps of methods can be presented herein in a particular order, alternative embodiments can perform the steps in a different order. Similarly, certain aspects of the present technology disclosed in the context of particular embodiments can be combined or eliminated in other embodiments. Furthermore, while advantages associated with certain embodiments of the present technology can have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics can be combined in any suitable manner in one or more embodiments.

Unless otherwise indicated, all numbers expressing concentrations, shear strength, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

What is claimed is:

1. A beverage pod, comprising:
a pod body defining an interior chamber configured to contain a beverage material;
a lidding coupled to the pod body and configured to seal the interior chamber; and
at least one pressure relief valve formed by the lidding and the pod body,
wherein the at least one pressure relief valve is configured to automatically open when a pressure differential between the interior chamber and an external environment exceeds a threshold level to allow egress of gas from the interior chamber, and to automatically close when the pressure differential falls below the threshold level to reseal the interior chamber.

2. The beverage pod of claim 1, wherein the pod body includes a rim extending outwardly from the pod body, and the lidding is coupled to an upper surface of the rim, wherein the lidding covers most of the upper surface of the rim and extends across most of a distance from the at least one pressure relief valve to an edge of the rim.

3. The beverage pod of claim 2, wherein a gas egress flow path is located between the lidding and the rim, wherein when the pressure differential between the interior chamber and the external environment exceeds a threshold level, gas flows along the gas egress flow path towards the at least one pressure relief valve.

4. The beverage pod of claim 3, wherein at least a portion of the lidding is configured to move away from the rim when the pressure differential exceeds the threshold level to create a flow path for gas egress.

5. The beverage pod of claim 1, wherein the at least one pressure relief valve includes a through hole extending through the lidding.

6. The beverage pod of claim 5, wherein the through hole has a tapered configuration.

7. The beverage pod of claim 1, wherein the at least one pressure relief valve includes a membrane positioned to allow gas flow therethrough while preventing liquid flow therethrough, wherein the membrane is gas permeable and liquid impermeable.

8. The beverage pod of claim 7, wherein the membrane is gas permeable to at least one of nitrogen, argon, carbon dioxide, helium, neon, krypton, and xenon, wherein the membrane is liquid impermeable to water.

9. The beverage pod of claim 1, further comprising a welded region connecting the lidding to the pod body.

10. The beverage pod of claim 9, wherein the welded region is an annular thermal weld surrounding the at least one pressure relief valve, wherein the at least one pressure relief valve includes a plurality of pressure relief valves that are evenly spaced along a rim of the pod body.

11. A beverage pod, comprising:
a pod body having a rim; and
a lidding having at least one perforation and coupled to the rim via a welded region to form at least one pressure relief valve,
wherein the lidding is configured to move away from the rim when internal pressure exceeds a threshold pressure to create a flow path through the at least one perforation, and
wherein the lidding is configured to move toward the rim to close the flow path when the internal pressure falls below the threshold pressure.

12. The beverage pod of claim 11, wherein the at least one perforation comprises a plurality of perforations spaced around a periphery of the lidding.

13. The beverage pod of claim 12, wherein the plurality of perforations have a tapered configuration.

14. The beverage pod of claim 11, wherein the welded region comprises an annular thermal weld.

15. The beverage pod of claim 14, wherein the welded region includes a necked region extending toward the at least one pressure relief valve, wherein the necked region extends most of a distance from an outer edge of the rim.

16. The beverage pod of claim 15, wherein the necked region includes flow directing regions configured to direct gas flow toward the at least one pressure relief valve.

17. A method of manufacturing a beverage pod, comprising:
positioning a lidding over a rim of a pod body, the lidding having at least one perforation; and
welding the lidding to the rim with a welding head having at least one pressure relief forming element extending through the at least one perforation to create a pressure relief valve that allows the lidding to move away from the rim when internal pressure exceeds a threshold to enable gas flow through the at least one perforation.

18. The method of claim 17, wherein the welding head concurrently forms a through hole, a gas escape channel, and a raised portion in the lidding.

19. The method of claim 17, wherein welding the lidding to the rim creates an annular thermal weld surrounding the pressure relief valve.

20. A welding head for manufacturing beverage pods, comprising:
a body configured to output energy for welding a lidding to a pod body; and
a plurality of pressure relief forming elements extending from the body,
wherein each pressure relief forming element has a tapered profile configured to create perforations in the lidding and to concurrently form a through hole, and a gas escape channel during a welding process,
wherein the plurality of pressure relief forming elements are positioned to form multiple pressure relief valves around a periphery of the lidding.

21. The welding head of claim 20, wherein the energy comprises at least one of thermal energy, ultrasonic energy, electromagnetic energy, radiofrequency energy, infrared energy, laser energy, and mechanical energy.
